(19) United States
(12) Patent Application Publication
(10) Pub. No.: US 2007/0025569 A1
(43) Pub. Date: Feb. 1, 2007

(54) Condenser microphone unit and condenser microphone

(75) Inventor: Hiroshi Akino, Machida-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/492,087

(22) Filed: Jul. 25, 2006

(30) Foreign Application Priority Data
Jul. 26, 2005 (JP) 2005-215393

(51) Int. Cl. H04R 25/00

(52) U.S. Cl. 381/174

(57) ABSTRACT

A condenser microphone unit and a condenser microphone with enhanced sensitivity and reduced noise that can further be miniaturized by devising a structure of a vibrator and peripheral members thereof is obtained. A condenser microphone unit that causes conversion into an electric signal by capacity change of a capacitor formed with a vibrator that vibrates by receiving sound and a fixed pole disposed opposite to the vibrator. The vibrator is a cylindrical member and the fixed pole is a columnar member disposed on an inner side of the vibrator. The vibrator is disposed through a spacer disposed on an outer circumferential surface of the fixed pole to form a cylindrical space sealed with the outer circumferential surface of the fixed pole, spacer, and vibrator.

### BACKGROUND OF THE INVENTION

1. Field of the Invention

The present invention relates to a condenser microphone unit and a condenser microphone that can enhance sensitivity even if miniaturized.

2. Related Background of the Invention

A condenser microphone unit used in a miniature microphone such as a tiepin microphone and a headset microphone is demanded to be as small as possible so that it is inconspicuous. Currently, a small-diameter condenser microphone unit whose diameter is approximately 2.5 mm has become commercialized to apply a polarization voltage by an electret.

FIG. 3 and FIG. 4 show a structure of a general conventional condenser microphone unit. In FIG. 3 and FIG. 4, reference numeral 12 denotes a case of a condenser microphone unit, that is, a unit case. The unit case 12 has a bottomed cylindrical shape and is shown upside down with a portion corresponding to a bottom at an upper side. A plurality of pores 121 to guide a sound wave inside the unit is formed on a flat wall on the upper side corresponding to the bottom and these pores 121 are covered with a front mesh (not shown) on an inner surface side of the unit case 12. Inside the unit case 12, a diaphragm assembly 30 is disposed in a location nearest to the bottom of the unit case 12. The diaphragm assembly 30 comprises a ring-shaped diaphragm supporter 24 and a diaphragm-shaped diaphragm 22 whose outer circumferential edge is fixed to an end face of the diaphragm supporter 24 by, for example, adhesion.

A fixed pole 16 is disposed opposite to the diaphragm 22 with a spacer 20 interposed. The spacer 20 is a ring-shaped member made of thin resin and is in intimate contact with an outer circumferential edge of a rear end face (lower end face in FIG. 3 and FIG. 4) of the diaphragm 22. There is a gap corresponding to a thickness of the spacer 20 between the diaphragm 22 and fixed pole 16. The fixed pole 16 uses a metallic disc as a base material and constitutes an electret board with an electret plate 18 attached at least on one face side, for example, on a face side opposite to the diaphragm 22. The diaphragm 22 and fixed pole 16 constitute a kind of capacitor and, as the diaphragm 22 vibrates in accordance with the sound wave guided through the front mesh, a capacitance of the capacitor changes and a change in capacitance is output as a sound signal. The diaphragm 22 changes its position based on a difference between an air pressure of a sealed space formed by the electret board 18, spacer 20, and inner surface of diaphragm 22, and an atmospheric pressure applied to the opposite surface of the diaphragm 22 caused by formation of the pores 121. When a sound wave is guided through the pores 121, a pressure applied to an atmosphere side of the diaphragm 22 varies in accordance with the sound wave and the diaphragm 22 vibrates accordingly.

Inside the unit case 12, a cylindrical fixed pole support 14 is disposed on a rear face side of the fixed pole 16. A circular step part 141 is formed by extending an inner circumference of a front end of the fixed pole support 14 toward the outside in a radial direction, and the fixed pole 16 is fitted into the step part 141. A disc-like printed circuit board 10 hits on the rear end face of the fixed pole support 14 and the printed circuit board 10 is fitted into a rear end open part of the unit case 12 to be fixed to the unit case 12 by appropriate fixing means, for example, by press fitting or caulking the rear end open part of the unit case 12. A force to press the fixed pole support 14, fixed pole 16, spacer 20, and diaphragm assembly 30 toward an inner bottom surface of the unit case 12 is applied in this order to the circuit board 10, and these members are fixed at predetermined locations.

A field-effect transistor (hereinafter referred to as “FET”) 26 constituting an impedance converter is disposed in a central part on a top face of the printed circuit board 10. Since an output impedance of a condenser microphone unit is extremely high, the impedance converter consisting principally of the FET 26 is incorporated. Part of terminals of the FET 26 is connected to a predetermined circuit pattern of a printed circuit board 8 by soldering or the like and one end of a contact 28 made of a curved elastic conductor is pressure-contacted to one of other terminals. The other end of the contact 28 is pressure-contacted to the fixed pole 16 and the contact 28 causes one of the terminals of FET 26 and the fixed pole 16 to be electrically conductive.

A condenser microphone unit used in a tiepin or headset condenser microphone is as extremely small as 2.5 mm in diameter D and 2.0 mm in length (height) L, and a structure thereof has basically no difference from that shown in FIG. 3 and FIG. 4. Nondirectional microphone units are used in most cases for a tiepin or headset condenser microphone unit. For example, a plastic film, as a base material, on which gold is vacuum-deposited, is used as a diaphragm 22. The diaphragm assembly 30 is constructed by affixing the diaphragm 22 to the ring-shaped diaphragm supporter 24.

In order to enhance sensitivity, reduce noise, and improve various characteristics of a condenser microphone unit, an effective capacity should be increased. A capacity that contributes to generation of an electric signal by vibration of the diaphragm 22 is called an effective capacity and, in the case of the condenser microphone unit, in addition to the effective capacity, there is a stray capacitance that reduces sensitivity. The effective capacity depends on an area of a vibrating portion of the diaphragm 22 and a distance to the fixed pole 16 (more specifically, to the electret plate 18). The stray capacitance is obtained by subtracting the effective capacity from the capacitance between the diaphragm 22 and fixed pole 16. The stray capacitance also includes an input capacitance of the FET 26 constituting the impedance converter. If the effective capacity and the stray capacitance are equal, sensitivity at a signal input end to the FET 26 would be reduced to half. Therefore, sensitivity of the condenser microphone unit can be enhanced by making the effective capacity larger and the stray capacitance smaller.

When the effective capacity is small, sensitivity is reduced, as described above, and in addition, intrinsic noise resulting from a gate part of the FET 26 increases. This intrinsic noise is called 1/f noise. An equivalent sound pressure level of the intrinsic noise of a large condenser microphone unit of, for example, 21 mm in diameter of the diaphragm 22 is approximately several dBSPL, but in the case of a small condenser microphone unit of about 2.5 mm in outside diameter, the equivalent sound pressure level of the intrinsic noise is approximately 30 dBSPL. The equivalent sound pressure level of the intrinsic noise of a microphone for broadcasting service is demanded to be 30 dBSPL or below. Therefore, the outside diameter of 2.5 mm can currently be said be a limit to miniaturization of the condenser microphone unit.

Miniaturization of the condenser microphone unit has also a problem in terms of manufacturing. As described above, the effective capacity should be increased to enhance sensitivity, and an area in which the diaphragm 22 functions effectively as a diaphragm should be broadened by increasing an inside diameter of the diaphragm supporter 24 to increase the effective capacity. However, a tiepin or headset microphone unit preferably has components including the diaphragm 22 and diaphragm supporter 24 that are made as small as possible and thus a condition conflicting with that of broadening an effective area of the diaphragm 22 must be satisfied. To satisfy this conflicting condition, making an adhesion margin of the diaphragm 22 with respect to the diaphragm supporter 24 as small as possible can be considered.

In a nondirectional condenser microphone unit, on the other hand, tension of the diaphragm 22 must be increased. This is because sensitivity must be enhanced by raising the polarization voltage, adsorption of the diaphragm 22 by the fixed pole 16 must be prevented by a high polarization voltage, and so on. However, when a plastic film is used as a material of the diaphragm 22, a creep may occur in the plastic material if tension is high and characteristics are degraded, and thus the tension is limited to an extent that no creep occurs in the plastic material. When, on the other hand, the adhesion margin is made small, as described above, an adhesion part cannot resist tension and the diaphragm 22 are more apt to fall off the diaphragm supporter 24. Thus, it is difficult for a conventional structure of the condenser microphone unit to make the diameter thereof smaller, and currently, as described above, the diameter of about 2.5 mm is considered to be a limit.

Next, vibration noise will be considered. When vibrations are applied to a microphone unit, the fixed pole vibrates together with the microphone unit, but the diaphragm attempts to stay on in its original location and a sound signal is emitted by a change in capacitance between the diaphragm and fixed pole. This sound signal is not caused by conversion from a sound wave into an electric signal, but vibration noise based on application of vibrations to the microphone unit. According to the structure of a conventional condenser microphone unit, the diaphragm is flat and thus the structure facilitates generation of the vibration noise.

Including the example shown in FIG. 3 and FIG. 4, diaphragms of conventionally known condenser microphone units are flat plate-like diaphragms (See, for example, Patent document 1, Patent document 2, Patent document 3, Patent document 4, Patent document 5, Patent document 6, Patent document 7, and Patent document 8). Therefore, there is a problem that the miniaturization described above is limited and generation of vibration noise is likely to occur.

[Patent document 1] Japanese Patent Application Laid-Open No. 2005-198196

[Patent document 2] Japanese Patent Application Laid-Open No. 2005-150991

[Patent document 3] Japanese Patent Application Laid-Open No. 2004-343377

[Patent document 4] Japanese Patent Application Laid-Open No. 2004-343368

[Patent document 5] Japanese Patent Application Laid-Open No. 2004-72235

[Patent document 6] Japanese Patent Application Laid-Open No. 2003-163997

[Patent document 7] Japanese Patent Application Laid-Open No. 2004-516725

[Patent document 8] Japanese Patent Application Laid-Open No. 2004-40584

### SUMMARY OF THE INVENTION

The present invention has been developed to resolve the above-mentioned problems of the conventional technologies and has an object to provide a condenser microphone unit and a condenser microphone with enhanced sensitivity and reduced noise that can further be miniaturized by incorporating novel ideas free from the conventional technologies with respect to a shape or structure of a vibrator and peripheral members.

The present invention is characterized as the most main feature in which a condenser microphone unit that forms a capacitor with a vibrator that vibrates by receiving sound and a fixed pole disposed opposite to the vibrator and causes conversion into an electric signal by capacity change of the capacitor, wherein the vibrator is a cylindrical member and the fixed pole is a columnar member disposed on an inner side of the vibrator.

The vibrator may be disposed through a spacer disposed on the outer circumferential surface of the fixed pole to form a sealed cylindrical space with the outer circumferential surface of the fixed pole, the spacer, and the vibrator.

A perimeter of the columnar fixed pole is enclosed by the vibrator and a capacitor is constituted by the fixed pole and vibrator. Since the vibrator and fixed pole expand three-dimensionally, instead of conventionally expanding two-dimensionally, it becomes easy to expand an effective area of the vibrator, increase the capacitance, and also raise a ratio of effective capacitance even if the diameter of the unit is limited. To increase the capacitance, the vibrator and fixed pole can be elongated in a central axis direction and sensitivity can also be enhanced while retaining a small diameter. When a physical force such as a vibration is applied from outside, the cylindrical vibrator is translated by approaching the fixed pole on one side and moving away from the fixed pole on the other side, and thus the capacitance increases on one side and decreases on the other side, advantageously canceling out change of the capacitance as a whole to make generation of noise more difficult.

### BRIEF DESCRIPTION OF THE DRAWINGS

FIG. 1 is a longitudinal sectional view showing an embodiment of a condenser microphone unit according to the present invention.

FIG. 2 is an exploded longitudinal sectional view of the embodiment.

FIG. 3 is a longitudinal sectional view showing an example of a conventional condenser microphone unit.

FIG. 4 is an exploded longitudinal sectional view of the conventional example.

### DESCRIPTION OF THE PREFERRED EMBODIMENTS

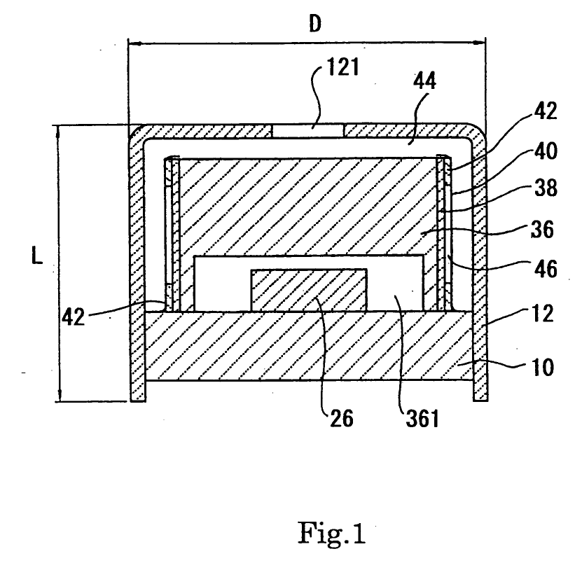

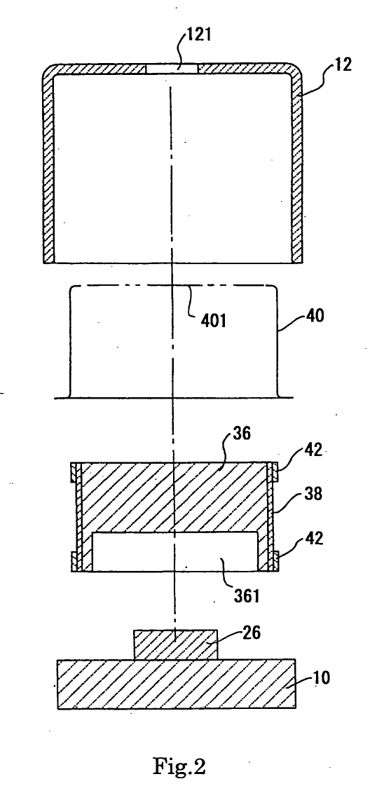

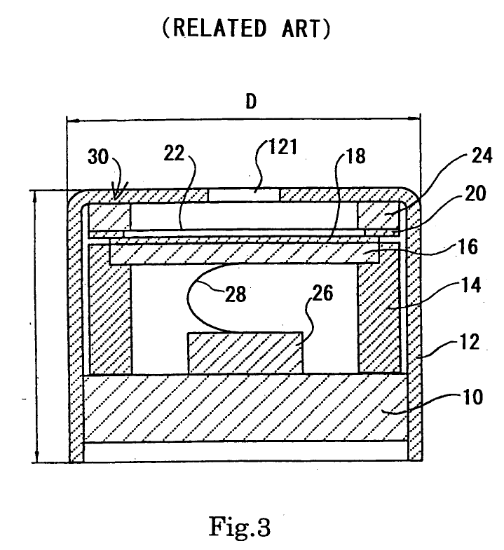

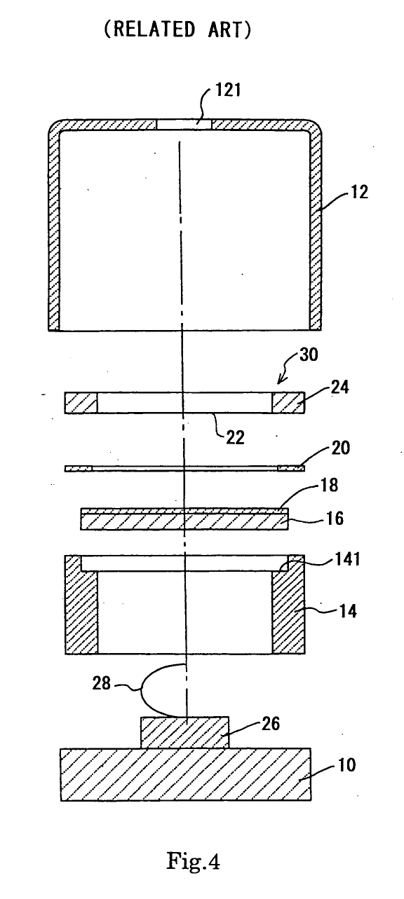

An embodiment of a condenser microphone unit and a condenser microphone according to the present invention will be described below with reference to FIG. 1 and FIG. 2. Here, the same reference numerals are attached to substantially the same components as those used in the conventional example shown in FIG. 3 and FIG. 4.

In FIG. 1 and FIG. 2, reference numeral 12 denotes a case of a condenser microphone unit, that is, a unit case. The unit case 12 has a bottomed cylindrical shape and is shown upside down with a portion corresponding to a bottom at an upper side. A plurality of pores 121 to guide a sound wave inside the unit is formed on a flat wall on the upper side corresponding to the bottom and these pores 121 are covered with a front mesh (not shown) on the inner surface side of the unit case 12.

Inside the unit case 12, the disc-like circuit board 10 is fitted into the inside of a lower end open part of the unit case 12 and fixed. Any fixing means of the circuit board 10 can be selected from press fitting, adhesion, caulking the lower end edge of the unit case 12 and the like. Inside the unit case 12, a columnar fixed pole 36, an electret layer 38, a spacer 42, a vibrator 40 and an FET 26, which is a main component of an impedance converter, are disposed.

The fixed pole 36 forms a space 44 between an inner circumferential surface of the unit case 12 and a ceiling surface corresponding to the bottom of the unit case 12 and is fixed onto the circuit board 10. A recess is formed on the bottom side of the fixed pole 36 and a circular sealed space 361 is formed by the recess and the circuit board 10. The FET 26 is disposed on the circuit board 10 and the FET 26 is positioned inside the space 361. The fixed pole 36 is made of a conductive material, for example, a metal.

The electret layer 38 is formed on the outer circumferential surface of the fixed pole 36 and the polarization voltage is applied to the electret layer 38. The electret layer 38 can be formed by, for example, putting a heat-shrinkable tube made of FEP (fluororesin: abbreviation of tetrafluoroethylene-hexafluoropropylene copolymer (4.6 fluorinated)) over the columnar fixed pole 36, fixing the tube to the outer circumferential surface of the fixed pole 36 by heat-shrinking, and performing electret treatment.

The cylindrical vibrator 40 is disposed on the outer circumference of the fixed pole 36, more specifically on the circumference of the electret layer 38 with the spacer 42 interposed. The cylindrical vibrator 40 has a radius larger than that of the fixed pole 36 (more correctly, that of the electret layer 38) by the thickness of the spacer 42, and there is a space 46 for the thickness of the spacer 42 between the vibrator 40 and fixed pole 36 (more correctly, the electret layer 38). The vibrator 40 has a length in the central axis direction approximately equal to that of the fixed pole 36, and the spacer 42 is fixed on the inner circumferential surface at both ends in the length direction of the vibrator 40 respectively and the inner circumferential surface of these spacers 42 is fitted into the outer circumferential surface of the electret layer 38 and fixed by suitable fixing means. Therefore, the sealed space 46 is formed by the outer circumferential surface of the fixed pole 36, upper and lower spacers 42, and vibrator 40. The vibrator 40 is formed by a membranous member so that it can vibrate in the radial direction by receiving a sound wave. For example, a metal film of nickel or the like is formed by electroforming, which is a kind of plating, and the formed metal film can be used as a vibrator. The thickness of the metal film is 5 to 10 μm.

As shown in FIG. 1, by placing the fixed pole 36 (more correctly, the electret layer 38) and the vibrator 40 opposite to each other with the space 46 therebetween, a capacitor having these electret layer 38 and vibrator 40 as electrodes is constituted. A space 44 is formed among the outer circumferential surface of the vibrator 40, inner circumferential surface of the unit case 12, and ceiling surface corresponding to the bottom of the unit case 12, and the space 44 communicate with outside air through the pores 121 formed on the unit case 12. Therefore, when a sound wave comes into the space 44 through the pores 121, a difference is generated between a pressure on the space 44 and a pressure on the sealed space 46, and the vibrator 40 vibrates in the radial direction due to a pressure difference in accordance with the sound wave. Since the pressure caused by a sound wave is generated in a direction that causes the vibrator 40 to shrink or expand all around the circumference of the vibrator 40, the capacitance of the vibrator 40 all around the circumference changes in accordance with the sound wave. The change of the capacitance is output as a sound signal.

In this way, since, according to the embodiment shown in FIG. 1 and FIG. 2, the capacitance increases in proportion to the area of the vibrator 40 facing the space 46 expanding in a circumferential direction, it is easy to increase the effective capacity compared with a flat-shaped diaphragm of a conventional condenser microphone unit by ensuring, to a certain extent, dimensions of the vibrator 40, fixed pole 36, and electret layer 38 in the central axis direction. The effective capacitance can also be increased by reducing a unit diameter D or elongating a dimension L in the central axis direction to obtain a condenser microphone unit with high sensitivity and low noise while having a small diameter.

According to the present embodiment, a condenser microphone unit with low vibration noise can be obtained. That is, when an impact force or vibration is applied to a unit, the fixed pole 36 and its integral component electret layer 38 vibrate together with the circuit board 10 and unit case 12, while the vibrator 40 attempts to stay on in its original location and is relatively displaced with respect to the fixed pole 36. Here, the relative displacement of the vibrator 40 is, in contrast to the case in which a sound wave is received, is a movement similar to a parallel translation, and the distance between the fixed pole 36 and vibrator 40 decreases on one side in a diametral direction while the distance between the fixed pole 36 and vibrator 40 increases on the other side in the diametral direction. Therefore, the capacitance increases on one side and decreases on the other side to cancel out each other as a whole so that this structure makes a level of output signal, that is, a noise level low and generation of vibration noise difficult.

In the description so far, the vibrator 40 was assumed to have a cylindrical shape, that is, a cylindrical shape with both ends open in the length direction, but may be a metal film having a bag-like shape with a bottom denoted by an imaginary line 401 in FIG. 2. The spacer 42 is fixed to upper and lower ends on the inner surface side of the bag-like vibrator 40, the vibrator 40 is put together with the spacer 42 over the fixed pole 36 from above, and the vibrator 40 is fixed to the fixed pole 36. A portion corresponding to the bottom of the bag-like vibrator 40 is brought into intimate contact with the top face of the fixed pole 36. Or, a space may be created between the portion corresponding to the bottom of the bag-like vibrator 40 and the top face of the fixed pole 36 to constitute a capacitor between the portion corresponding to the bottom of the bag-like vibrator 40 and the top face of the fixed pole 36 to further increase the effective capacitance.

The embodiment shown is an example of an electret condenser microphone unit in which the electret layer 38 is formed on the outer circumference of the fixed pole 36, but a condenser microphone unit omitting the electret layer 38 will also do.

The condenser microphone unit shown in FIG. 1 and FIG. 2 can be made to be a condenser microphone by incorporating the condenser microphone unit into a microphone case and further incorporating necessary circuits into the microphone case. A transmitter is incorporated into a wireless pin microphone or a headset microphone, and a connector for connecting a cable is incorporated into a cable-connected microphone.

In the present invention, a diaphragm and a fixed pole are devised based on ideas completely different from those of a conventional condenser microphone or a condenser microphone unit, and a highly sensitive condenser microphone unit and condenser microphone can be obtained by increasing the effective capacitance while retaining a small diameter. Therefore, the present invention will be very likely to be widely applied to uses where miniaturization is required such as a pin microphone and a headset microphone.

What is claimed is:

1. A condenser microphone unit which forms a capacitor with a vibrator that vibrates by receiving sound and a fixed pole disposed opposite to the vibrator and causes conversion into an electric signal by capacity change of the capacitor, wherein
the vibrator is a cylindrical member and the fixed pole is a columnar member disposed on an inner side of the vibrator.

2. The condenser microphone unit according to claim 1, wherein the vibrator is disposed through a spacer disposed on an outer circumferential surface of the fixed pole and a cylindrical space sealed with the outer circumferential surface of the fixed pole, the spacer, and the vibrator is formed.

3. The condenser microphone unit according to claim 2, wherein the vibrator and the fixed pole are disposed in a unit case and the outer circumferential surface of the vibrator is open to an external space through a space inside the unit case and pores drilled in the unit case.

4. The condenser microphone unit according to claim 2, wherein an electret layer is formed on the outer circumferential surface of the fixed pole and the vibrator is disposed opposite to the electret layer.

5. The condenser microphone unit according to claim 4, wherein the electret layer is obtained by performing electret treatment on a heat-shrinkable tube put over the fixed pole.

6. The condenser microphone unit according to claim 1, wherein the vibrator is made of a cylindrical metal film with both sides thereof opened.

7. The condenser microphone unit according to claim 1, wherein the vibrator is made of a bag-like metal film with one end thereof closed.

8. The condenser microphone unit according to claim 1, wherein the vibrator is a metal film produced by electroforming.

9. A condenser microphone, wherein a condenser microphone unit according to any of claims 1 to 8 is incorporated inside a microphone case and a sound signal converted by the condenser microphone unit is output to an outside.
